(19) United States
(12) Patent Application Publication
(10) Pub. No.: US 2014/0263343 A1
(43) Pub. Date: Sep. 18, 2014

(54) Inground Protective Housing

(71) Applicant: Rain Bird Corporation, Azusa, CA (US)

(72) Inventors: Steven David Geerligs, Vail, AZ (US); Brian Mueller, Vail, AZ (US)

(21) Appl. No.: 13/801,489

(22) Filed: Mar. 13, 2013

(51) Int. Cl. F16L 57/00

(52) U.S. Cl. CPC F16L 57/00
USPC 220/484

(57) ABSTRACT

An improved inground protective housing for components of underground systems is provided. The housing is configured so that it may be placed over the components that are already installed in the ground. Window knockouts, as well as an easily removable bottom flange portion corresponding to a window knockout, are provided to ease the installation of the housing.

### FIELD

The present invention relates to a protective housing structure and lid for underground devices such as meters, valves, sensors, and filters.

### BACKGROUND

Inground protective housings have been in use for some time in protecting underground systems such as irrigation systems. These housings often have open bottoms so that they can be positioned over the inground component with the top of the housing being flush or slightly above or below the grade level. While older underground housings were constructed of concrete, more recent housings have been molded from plastic.

In the irrigation industry, these housings are referred to as valve boxes and are used to protect not only valves, but also meters, sensors, and filters. During installation, the housings are customized with cutouts to facilitate installation over irrigation supply pipe and control wires. To do so, the valve boxes sometimes have knockouts to assist the user in removing one or more sections or pieces from the sides of the box when it is necessary to run wires or pipes through the sides. A user will either place the valve box in the ground first and later run piping through the knockouts, or more often, a user will install the piping first and later place the customized cut valve box over the piping. Prior art valve boxes often have a flange or some form of support around the bottom that must also be removed in part in order to install the valve box over top of the piping or wiring. This can be difficult and time consuming because the flange is generally a robust structural component of the box, and therefore, requires a tool, such as a saw or chisel, to remove it.

Accordingly, there remains a need for an inground system protective housing with an improved structure that facilitates an easy customizable box for expedited positioning over components of an inground system that extend into the housing.

### BRIEF DESCRIPTION OF THE DRAWINGS

FIG. 1 is a perspective view of a housing having a lid and a knockout removed;

FIG. 2 is a perspective view of the housing of FIG. 1 with the lid removed and knockouts intact;

FIG. 3 is an enlarged perspective view of a portion of the housing of FIG. 2 showing two knockouts and a flange portion;

FIG. 4 is a bottom plan view of the housing of FIG. 2;

FIG. 5 is a bottom perspective view of the housing of FIG. 2;

FIG. 6 is an enlarged perspective view of a portion of the housing of FIG. 2 with a knockout and partial flange removed;

FIG. 7 is an enlarged perspective view of a portion of the housing of FIG. 2 with a removed knockout partially covering an opening; and

FIG. 8 is a cross-sectional view of groove shapes for a frangible connection at a flange of a housing.

### DETAILED DESCRIPTION OF THE PREFERRED EMBODIMENTS

Referring to FIG. 1, an improved inground protective housing or box 10 for use with underground systems, such as irrigation systems, is shown. The box 10 is shown configured so that it may be placed over irrigation piping 13 or components 15 that are already installed in the ground 17. Existing boxes often feature a knockout 28 with a weakened perimeter that facilitates easy removal of the knockout 28 to aid a user with installation. The box 10 also includes a flange structure 21, coordinated with the knockouts, to also assist in the removal of a portion of a flange 23. The improved flanged structure 21, as described further below, renders customizing the box 10 for over top installation much quicker and easier with controlled removal of the main supporting flange 34 and connecting ledge 36.

Referring to FIGS. 2-5, the box 10 has a plurality of walls 12 forming an interior cavity 14, a generally rectangular-shaped upper opening 16 leading into the interior cavity 14, and a generally rectangular-shaped lower opening 18 leading into the interior cavity 14. The upper opening 16 has an upper opening perimeter 20, and the lower opening 18 has a lower opening perimeter 22. The housing walls 12 taper inward so that the upper opening perimeter 20 is smaller than the lower opening perimeter 22. Each of the walls 12 has an outer surface 24, and an inner surface 26. A plurality of window knockouts 28 are formed in the housing walls 12. Each window knockout 28 has three generally rectilinear sides 30 and a generally curve-shaped side 32, and is constructed to have a frangible transition with the wall 12 and ledge 36.

The flange 34 extends radially outward from the lower perimeter 22 around the lower opening 18. The flange 34 includes the connecting ledge 36 extending from the walls 12 and a lip 37 that extends from the ledge 36. The ledge 36 is defined by a top surface 38 and a bottom surface 39. The thickness of the ledge 36 can be less than that of the lip 37. It may be as much as about half the thickness of the lip 37. The flange 34 is supported by a series of upstanding ribs 40 that interconnect the wall 12, the ledge 36, and the lip 37 together. The walls 40 are disposed on each side of each knockout 28.

With reference to FIG. 5, a series of grooves 42 are formed in the outside of flange 34 and the bottom of the ledge 36. More specifically, each groove 42 extends outward in bottom of the ledge 36 and wraps onto the flange 34. Each pair of grooves corresponds to the outer side edges of a knockout 28. The grooves 42 reduce the thickness of the material surrounding a portion of the flange 34 and ledge 26 to functions as a frangible connection of the flange 34 and ledge 36 for the corresponding knockout 28. The portion of the groove 42 in the bottom of the ledge may have a width and depth of 0.125 inches, and the portion of the groove extending in the outer side of the flange 34 may have a width of 0.125 inches and a depth of 0.175 inches. The depth dimension may taper outward slightly to accommodate tooling. The reduction in thickness of the material at the frangible connection could be as much as half the thickness of the flange surrounding material. The material of the flange adjacent the groove can be 0.375 inches thick. The thickness of the ledge adjacent the groove can be around 0.303 inches.

Referring to FIG. 8, the grooves 42 can be of any cross-section geometry, e.g., a U-shape 42a, a triangular-shape 42b, or a rectangular-shape 42c. There also may be grooves 42 in the top side of the ledge 36 and inside surface of the flange 34 in addition or as an alternative (see FIG. 3).

Referring to FIGS. 4-7, each window knockout 28 is preferably held in place with two frangible connection points with the housing wall 12 and ledge 36. More specifically, a knockout extension 44 or rib having a thickness that is about the same as the surrounding wall portion extends from the inner surface 26 of the housing wall 12 across the generally curve-shaped side 32 of the window knockout 28 and onto an inner face 46 of one end of the knockout 28. The extension 44 provides a frangible connection 48 between the window knockout 28 and the housing wall 12. Each window knockout 28 is further connected to the ledge 36 along the bottom of the knockout 28 between points 54. Thus, there are only two connections between the window knockout 28 and the housing 10 with a gap 46 formed between the window knockout 28 and the housing at all other places on the knockout perimeter, thus permitting easier removal. Alternatively, the frangible connection points can be replaced with a thin walled continuous connection.

As best seen in FIGS. 6 and 7, a user forcibly strikes, bends or twists a portion 48 of the flange 34 defined by the grooves 42, to cause the frangible connection created by the grooves 42 to fracture. A joint 50 is formed where the ledge 36 meets the housing wall 12. Because of the reduced thickness of the ledge 36 compared to the surrounding material, further bending of the portion 48 will cause the material at 50 to fracture as well.

The ribs 40 support and prevent unintentional fracturing of adjacent flange portions 48. This allows the flange portion 48 to be easily removed, creating a gap 52 in the flange 34 corresponding to the knockout. The window knockout 28 is bent inward until the extension 44 breaks. When broken, the extension 44 permits removal of the window knockout 28 from the housing wall 12, thus completing an opening 56 into the interior cavity 14 through which underground piping, wiring, or other components may pass into the box 10. With the flange portion 48 removed, the box 10 also can be placed over existing piping or components for ease of installation.

Referring to FIG. 7, adjacent to and disposed above each window knockout 28 or knockout opening 56 is a wall coupler, which in the illustrated embodiment is a pair of vertically-oriented wall ribs 58. These ribs 58 are adapted to mate with the knockout coupler, i.e., the rib or extension 44 formed on the inner face 46 of each window knockout 28, so that after the knockout 28 is removed from the housing wall 12, the window knockout 28 can be removably connected to the wall ribs 58. Because the walls 12 are slanted inward toward the cavity 14, gravity inhibits the window knockout 28 from falling outward away from the wall 12. Moreover, the pair of wall ribs 58 interlock with the knockout rib 34, thus inhibiting transverse removal of the window knockout 28 from the housing wall 12. When the window knockout 28 is so attached to the housing wall 12, the window knockout 28 can rest on irrigation pipe 13 or conduit 60 extending through the knockout opening 56 and cover the portion of the opening 56 that is disposed above the irrigation pipe 13 or conduit 60. This can inhibit the introduction of dirt into the interior cavity 14 of the box 10 when the location in the ground in which the box 10 is placed is being back-filled.

Additional description of the valve box 10 is in U.S. Pat. No. 7,243,810, issued on Jul. 17, 2007 and is hereby incorporated by reference. Many different box designs could utilize the easily removable flange.

While the foregoing description is with respect to specific examples, those skilled in the art will appreciate that there are numerous variations of the above that fall within the scope of the concepts described herein and the appended claims.

What is claimed is:

1. An inground protective housing comprising:
at least one wall forming an interior cavity and having a flange;
at least one knockout formed in the at least one wall and adapted for removal from the at least one wall to form a first opening into the interior cavity;
at least one flange portion corresponding to the at least one knockout and adapted for removal to form a breach in the flange; and
at least one frangible connection defining the first flange portion of the frangible connection configured to fracture from the flange.

2. The housing of claim 1 wherein the at least one frangible connection has a first thickness, the flange has a second thickness, and the first thickness being less than the second thickness.

3. The housing of claim 1 further comprising at least one wall extending between the at least one wall and the flange adjacent the at least one frangible connection.

4. The housing of claim 3 wherein the at least one frangible connections includes two frangible connections and the at least one wall comprises two walls and each wall being adjacent one of the two frangible connections.

5. The housing of claim 2 wherein the at least one frangible connection is formed from at least one groove.

6. The housing of claim 5 wherein the at least one grooves has a rounded cross-section.

7. The housing of claim 5 wherein the at least one grooves has a triangular cross-section.

8. The housing of claim 5 wherein the at least one grooves has a rectangular cross-section.

9. The housing of claim 1 wherein the at least one knockout comprises a plurality of knockouts, a second frangible connection attaching each knockout to the at least one wall of the housing.

10. The housing of claim 9 wherein the at least one flange portion comprises a plurality of flange portions and each of the plurality of flange portions corresponds to one of the plurality of knockouts.

11. The housing of claim 10 further comprising a plurality of walls adjacent the plurality of flange portions.

12. The housing of claim 11 wherein each flange portion is bounded by two of the walls.
